(19) United States
(12) Patent Application Publication
(10) Pub. No.: US 2008/0128204 A1
(43) Pub. Date: Jun. 5, 2008

(54) HUNTING STAND

(75) Inventor: Jay C. Engstrom, Luck, WI (US)

Correspondence Address: FAEGRE & BENSON LLP;PATENT DOCKETING, 2200 WELLS FARGO CENTER, 90 SOUTH SEVENTH STREET, MINNEAPOLIS, MN, 55402-3901, US

(73) Assignee: Ardisam, Inc., Cumberland, WI (US)

(21) Appl. No.: 11/627,772

(22) Filed: Jan. 26, 2007

Related U.S. Application Data
(60) Provisional application No. 60/867,892, filed on Nov. 30, 2006.

(51) Int. Cl. A01M 31/02; E06C 7/16

(52) U.S. Cl. 182/116; 182/187

(57) ABSTRACT

A portable tree stand for elevating a hunter or observer above the ground is described. The tree stand can be sized such that it can accommodate one or two users. The tree stand includes a frame assembly that can be reconfigured to allow a user or users to face multiple directions. The railings are adjustable to maximize the functionality of the tree stand in each of the multiple directions.

### CROSS-REFERENCE TO RELATED APPLICATION

This application claims priority from U.S. Provisional Patent Application No. 60/867,892, filed on Nov. 30, 2006, entitled “Hunting Stand,” which is incorporated herein by reference in its entirety.

### TECHNICAL FIELD

The present invention relates generally to tree stands of the type adapted to be supported upon the trunk of a tree (or a similar vertical support) to elevate a hunter above the ground. More particularly, the present invention is directed to a portable tree stand which allows the hunter to face in multiple directions.

### BACKGROUND OF THE INVENTION

Tree stands provide a number of practical advantages to the hunter. For example, the skilled hunter who must wait for relatively long periods of time until a suitable game animal approaches will find it desirable to assume a comfortable position where his view of the surrounding area is relatively unobstructed, and where his relative safety is assured. In areas of dense woods, it is particularly advantageous for the observer to elevate himself well above the ground so that he may have unobstructed command of a sufficient area of woods.

It is well known by hunters that portable, easily installed tree stands facilitate greater user freedom, require less financial sacrifice, and waste less hunting time. If properly assembled and correctly situated, a tree stand can provide the user with a clear view of a broad area, enhancing the hunter's chances of success. A suitable tree stand must be lightweight, easily transportable, and it must be capable of simple, quick deployment, without the use of numerous additional hand tools. Most importantly, it must be easily accessible by the user, particularly in areas where the woods are dense and a higher elevation is desired for observation. Additionally, the stand must be securely mounted, stable and capable of rigidly maintaining itself in a constant position to adequately support one or more users.

Typical tree stands are configured such that the hunter faces away from the tree or vertical support, in a single direction, when waiting for game to wander by the stand. This limits the viewing direction as well as the shooting direction often resulting in a frustrating hunt. Thus, a need exists to provide a more versatile tree stand that allows a hunter to view and shoot game from more than one direction while at the same time proving a safe and secure support.

### BRIEF SUMMARY OF THE INVENTION

The present invention relates generally to portable tree stands adapted to be supported upon the trunk of a tree or a vertical support.

In one embodiment, the portable tree stand includes a platform and a frame attached to the portable tree stand above the platform. The frame includes at least one railing. At least one multi-directional seat is attached to the frame. The multi-directional seat includes a front edge and a rear edge, such that a front portion of the platform extends beyond the front edge of the multi-directional seat and a rear portion of the platform extends beyond a rear edge of the multi-directional seat. A user can sit facing at least the front portion or the rear portion of the platform.

The present portable tree stand can be supported by a ladder or can be configured as a hanging tree stand. The ladder preferably includes at least one stabilizing structure adapted to attach the ladder to the tree or other vertical support. The ladder can optionally be a folding ladder.

The railing is preferably adapted to pivot between at least a first position and a second position. In one embodiment, the railing includes a moveable shooting rail proximate the front portion of the platform in the first position and proximate the rear portion of the platform in the second position. In another embodiment, the present tree stand is provided with a plurality of railings pivotally attached to the frame. The railing optionally includes at least one backrest pivotally attached to the frame portion and at least one shooting rail pivotally attached to the frame. In another embodiment, the railings include a pair of backrests pivotally attached to the frame portion. The backrest can be a split backrest including first and second backrests each independently pivotable between at least a first position and a second position.

The frame assembly can be configured for a first user to sit facing the front portion of the platform, and a second user to simultaneously sit facing the rear portion of the platform.

The multi-directional seat is optionally releasably attached to the frame and repositionable at a plurality of locations between the front portion and the rear portion of the platform. In another embodiment, the multi-directional seat is slideably attached to the frame between the front portion of the platform and the rear portion. The multi-directional seat is preferably infinitely positionable along the frame between the front portion of the platform and the rear portion. The multi-directional seat is typically a bench seat.

A variety of stabilizing structures can be used. In one embodiment, a first stabilizing member is attached to the ladder at a first end and the tree at a second end. The second end is located below the platform. A second stabilizing member is attached to the ladder at a first end and to the first stabilizing member at the second end.

In another embodiment, a first stabilizing member includes a first end attached to the ladder and a second end attached to the tree at a location below the platform. A second stabilizing member includes a first end attached to the ladder and a second end attached to the tree at a location below the platform. The first and second stabilizing members are optionally pivotally attached to one another at a mid point.

The present invention is also directed to a method of using a portable tree stand. A frame assembly is attached to a platform. The frame assembly includes at least one railing. At least one multi-directional seat is attached to the frame assembly at a location that permits a user to sit facing a front portion of the platform or a rear portion of the platform. The tree stand is secured to a tree or another vertical support. The multi-directional seat can optionally be repositioned on the frame assembly.

### BRIEF DESCRIPTION OF THE SEVERAL VIEWS OF THE DRAWING

FIG. 1 is a perspective view of a tree stand in accordance with an embodiment of the present invention.

FIG. 2 is a perspective view of a tree stand in accordance with another embodiment of the present invention.

FIG. 3 is a perspective view of a tree stand in accordance with yet another embodiment of the present invention.

FIG. 4 is a perspective view of a top portion of a tree stand including a platform and a frame in accordance with an embodiment of the present invention.

FIG. 5 is a perspective view of a top portion of a tree stand including a platform and a frame in accordance with another embodiment of the present invention.

FIGS. 6-11 are perspective views of a platform including adjustable railings and a multi-directional seat arranged in accordance with various embodiments of the present invention.

FIG. 12 is a perspective view of a platform including a frame and an adjustable multi-directional seat according to yet a further embodiment of the present invention.

FIG. 13 is a perspective view of a tree stand according to an alternate embodiment of the present invention.

While the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION OF THE INVENTION

In the description which follows, like parts or elements are marked throughout the specification and drawings with the same reference numerals, respectively. The drawing figures are not necessarily to scale and certain features may be shown in somewhat generalized or schematic form in the interest of clarity and conciseness.

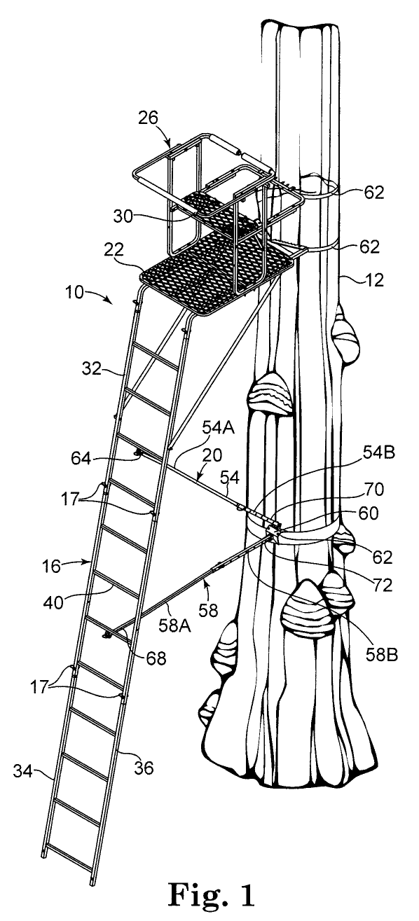

FIGS. 1-3 show perspective views of a portable tree stand 10 for use by game hunters and observers, in accordance with one embodiment of the present invention. As shown in FIG. 1, the tree stand 10 is secured to a tree 12 or another vertical support. The tree stand 10 includes a platform 22, a frame 26, and at least one multi-directional seat 30.

The portable tree stand 10 can be constructed of any suitable material capable of bearing weight and withstanding the weather elements. For example, the tree stand 10 may be constructed of powder-coated all-weather steel, fiber reinforced thermoset resins, natural or engineered wood products, composite materials, and/or combinations thereof. The tree stand 10 can optionally be camouflaged and/or covered by a blind to conceal a user's presence. Additionally, the tree stand 10 can be constructed so as to support the weight of more than one adult user.

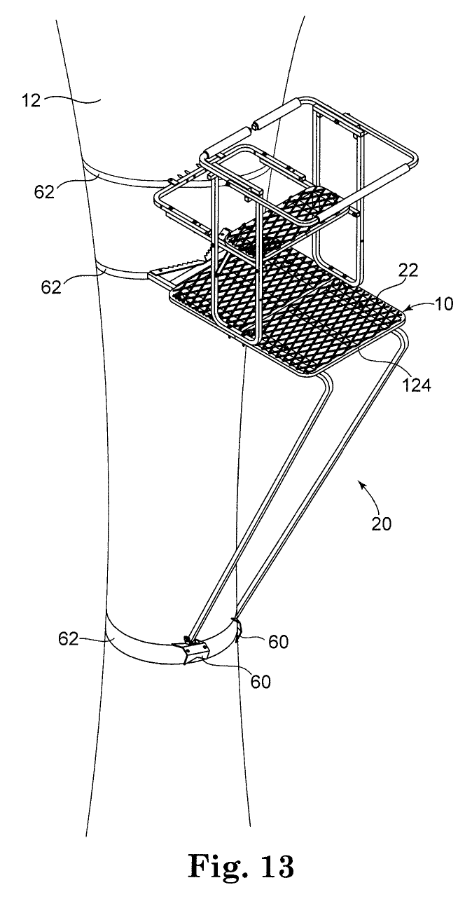

The portable tree stand 10 can include an optional ladder 16, as shown in FIGS. 1-3. Alternatively, the portable tree stand 10 is a hanging tree stand, and is secured to the tree or other vertical support using one or more flexible members, as best shown in FIG. 13, which will be discussed in further detail below.

The ladder 16 can have a variety of configurations as are known in the art. In general, the ladder 16 includes an upper portion 32 and a lower portion 34. The ladder 16 typically includes at least one stringer 36 and a plurality of spaced-apart rungs 40. According to the embodiment of FIG. 1, the ladder 16 includes a pair of stringers 36 connected to plural, transverse spaced-apart rungs 40. According to a further embodiment, the ladder 16 can be a folding ladder such as described in U.S. Pat. No. 4,742,888, which is herein incorporated by reference. Alternatively, the ladder 16 can include two or more sections that can be releasably secured together using fasteners 17, such as for example, quick-clip connectors or other suitable mechanisms as are known in the art.

According to the embodiments shown in FIGS. 1-3, the tree stand 10 preferably can include a stabilizing structure 20 for stabilizing and securing the ladder stand 10 to the tree 12. The stabilizing structure 20 of the embodiment of FIG. 1 includes support members 54 and 58 attached to the tree via a bracket 60. In general, the bracket 60 or fastener must be capable of effectively engaging and securing a member 62 attached to the tree, such as for example the flexible strap shown in FIG. 1

One or both support members 54, 58 may be rigid members, operating on both compression and tension. In the embodiment of FIG. 1, the support member 54 includes a first portion 54A and a second portion 54B. The first portion 54A preferably slides telescopically within the second portion 54B, permitting the user to adjust the length of the support member 54. Similarly, the support member 58 includes a first portion 58A and a second portion 58B. The first portion 58A preferably slides telescopically within the second portion 58B, permitting the user to adjust the length of the support member 58. In one embodiment of the present invention, the support members 54, 58 are metal, hollow tubular structures. Alternatively one or both support members 54, 58 can be flexible tension members, such as for example ropes, chains, cables or straps.

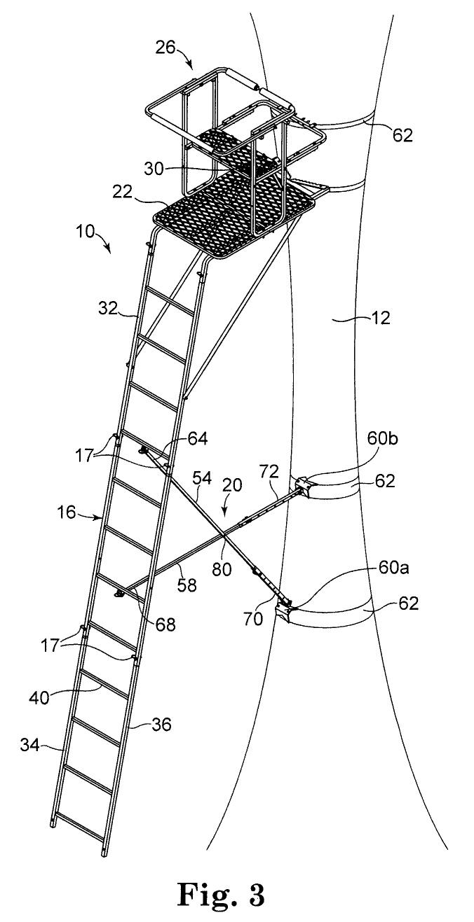

FIGS. 1-3 show various alternate arrangements of the stabilizing structure 20. According to one embodiment of the present invention, as shown in FIG. 1, the stabilizing structure 20 includes first and second support members 54, 58 each having a first end 64, 68 releasably connected to the ladder 16 and a second end 70, 72 releasably connected to the bracket 60 at a location below the platform 22. The bracket 60 is preferably secured to the tree by a flexible member 62, such as for example a nylon strap. In an alternate embodiment, second ends 70, 72 of the support member 54, 58, respectively, each include a bracket 60a, 60b that is attached to the tree 12 at separate locations, such as illustrated generally in FIG. 3.

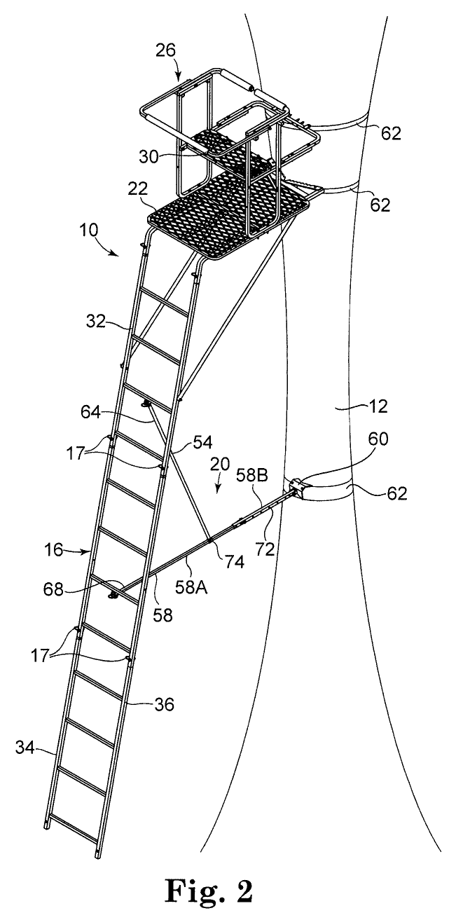

According to another embodiment of the present invention, as shown in FIG. 2, the stabilizing structure 20 includes a first support member 58 having a first end 68 connected to the ladder 16 and a second end 72 connected to the tree 12 via a bracket 60 at a location below the platform 22. In the illustrated embodiment, the first support member 58 includes a first portion 58A telescopically engaged with a second portion 58B. A second support member 54 having a first end 64 connected to the ladder 16 is connected at a location 74 along the first support member 58. In the illustrated embodiment, the location 74 is approximately the mid-point along the length of the first support member 58. The second support member 54 can optionally include first and second portions to permit the length to be adjusted. The location 74 is optionally adjustable along the length of the first support member 58. According to a further embodiment, the second support member 54 can be pivotally connected to the first support member 58 at the location 74.

According to yet another embodiment of the present invention, shown in FIG. 3, the stabilizing structure 20 includes a first support member 54 having a first end 64 connected to the ladder 16 and a second end 70 connected to the tree 12 via a bracket 60a and a second support member 58 having a first end 68 connected to the ladder 16 and a second end 72 connected to the tree 12 via an additional bracket 60b. The first support member 54 is preferably pivotally connected to the second support 58 member at location 80 such that the first and second members 54, 58 are moveable relative to one another in a scissor like fashion and can be collapsed against the ladder 16 when not in use. For example, if one of the ends 64, 68 is disconnected from the ladder 16, the stabilizing structure 20 can be folded flat against the rungs 40.

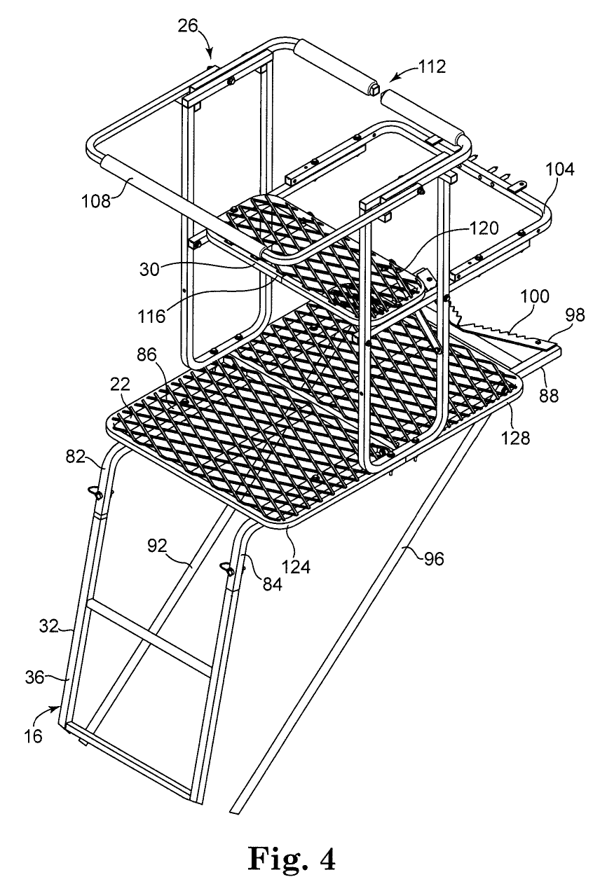

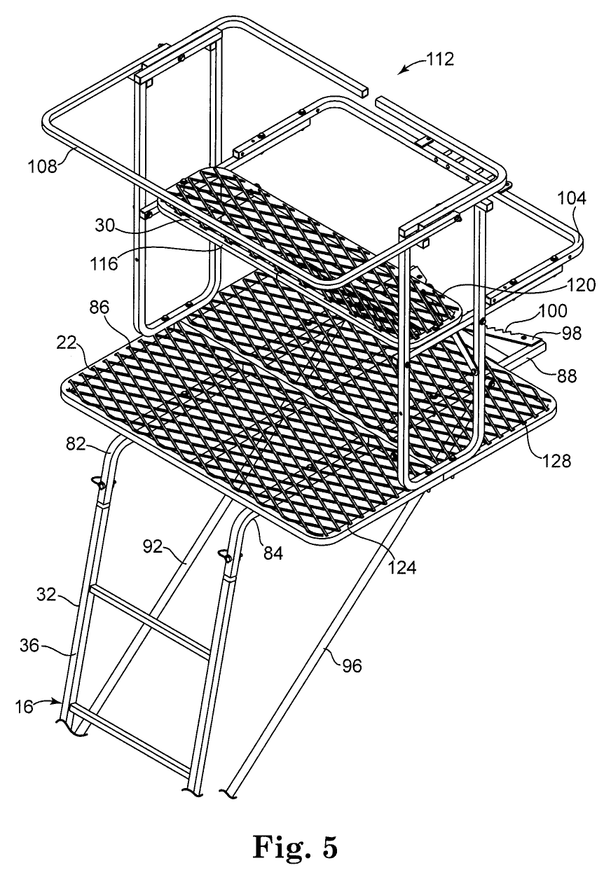

FIGS. 4 and 5 are close-up perspective views of the upper portion 32 of the ladder 16. FIG. 4 shows a platform 22 better suited to accommodate a single user, while FIG. 5 shows a platform 22 better suited to accommodate two users.

The stringers 36 optionally include upper curved portions 82 and 84 and laterally extending distal portions 86 and 88 upon which the platform 22 is supported. Optional support braces 92 and 96 extend from the stringers 36 to an underside of the platform 22 to provide extra support for the platform 22. As shown in FIGS. 4-5, the platform 22 is attached to the laterally extending distal portions 86, 88. The platform 22 is secured to the laterally extending distal portions 86, 88 of the ladder 16 using any suitable fastening means such as quick-release connecters, pins, bolts, etc.

The tree stand 10 also includes a tree blade 98. The tree blade 98 provides additional stability and security for the tree stand 10. As shown in FIGS. 4 and 5, the tree blade 98 extends from the platform 22 between the distal portions 86 and 88 and preferably includes a serrated edge 100 for gripping the tree 12. The tree blade 98 optionally includes a flexible member 62 for further securing and stabilizing the tree stand 10 to the tree 12.

A frame 26 is secured to the tree stand 10 at a location above the platform 22. The frame 26 can be secured to the platform 22 and/or the upper portion 32 of the ladder.

As shown in FIGS. 4-10, the multi-directional seat 30 is secured to the frame 26. The multi-directional seat 30 is generally rectangular in shape and includes a front edge 116 and a rear edge 120. Non-rectangular seat configurations are also contemplated by the present invention. The multi-directional seat 30 is positioned on the frame 26 so that a front portion 124 of the platform 22 extends beyond the front edge 116 and a rear portion 128 of the platform 22 extends beyond the rear edge 120. In this manner, the platform 22 provides a surface to support the users' feet regardless whether the user is facing the front portion 124 or the rear portion 128. Additionally, this configuration allows a user to sit facing at least the front portion 124 or the rear portion 128 of the platform 22. Alternatively, a user may straddle the multi-directional seat 30 and face toward the sides.

As used herein, the term “multi-directional seat” refers to a stationary seat located above a platform that permits a user to face in multiple directions, without moving or reconfiguring the seat. Multiple users seated on the multi-directional seat can each face in different directions simultaneously. The platform provides a foot rest in each of the multiple directions. Since the platform provides a foot rest on each side of the multi-directional seat, a user can straddle the multi-directional seat to face toward a side.

A plurality of railings 104, 108, 112 are attached to the frame 26. According to one embodiment of the present invention, the railings 108 and 112 are pivotally attached to the frame 26. The railings 104, 108, 112 can be constructed from a variety of materials, such as metal, plastic, composites or combinations thereof. The railings 104, 108, 112 optionally include padding for the comfort of the users.

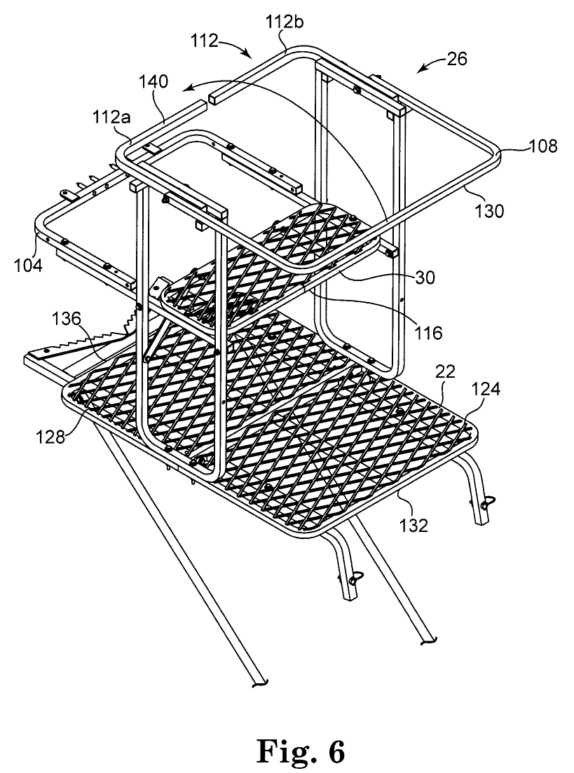

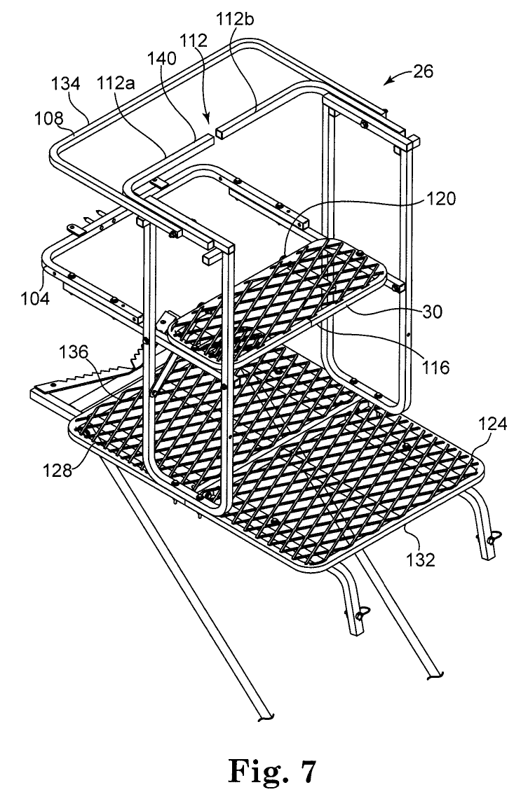

Railing 104 is a guard rail and can be secured to the tree 12 using a flexible member 62. Railing 108 is preferably a gun rail. The railing 108 is preferably secured to the frame 26 with a bolt or other fastening structures that permit pivotal movement. The railing 108 is moveable between a first position 130 (shown in FIG. 6) proximate a front edge 132 of the platform 22 and a second position 134 (shown in FIG. 7) proximate a rear edge 136 of the platform 22. The full range of motion of the railing 108 is approximately 180 degrees, but can be adjusted as necessary. The railing 108 can be placed in the second position 134 to allow for bow hunting from the tree stand 10 or to reconfigure the frame 26 such that the user or users can face in a different direction on the platform 22.

The railing 112 is preferably a backrest. Like the railing 108, the backrest 112 is pivotally attached to the frame 26 using a bolt or other fastening structures that permit pivotal movement. According to one embodiment of the present invention, the frame 26 includes a pair of backrests 112a and 112b (referred to collectively as “112”). Each backrest 112 is pivotally attached to the frame 26 and is independently moveable between a first position 140 proximate the rear portion 128 of the platform 22 and a second position 144 proximate the front portion 124 of the platform 22.

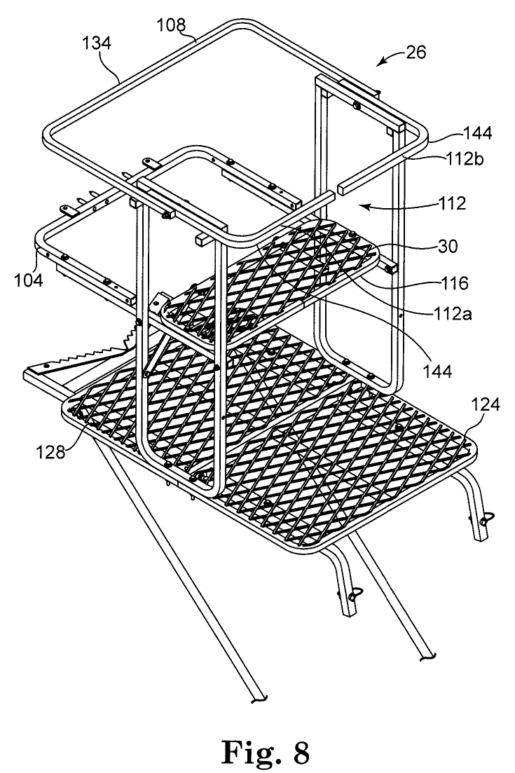

As best shown in FIGS. 6-11, the frame 26 can be configured to allow a user or users to face either the front portion 124 or the rear portion 128 of the platform 22. With the gun railing 108 and backrest 112 in their first positions (shown in FIG. 6), one or two users can sit in the tree stand 10 facing the front portion 124 of the platform 22 resting their guns on the railing 108 in front of them. If bow hunting, the gun railing 108 can be moved to the second position 134 (shown in FIG. 7) proximate the rear portion 128 of the platform 22 such that the railing 108 is now behind the user or users allowing for a clear shot with a bow. Additionally, the frame 26 can be configured such that the gun railing 108 and the backrest 112 are in their second positions 134 and 144 (as shown in FIG. 8) allowing a user or users to face the rear portion 128 of the platform. Again, if bow hunting, the gun rail 108 can be moved to a position that is behind the users.

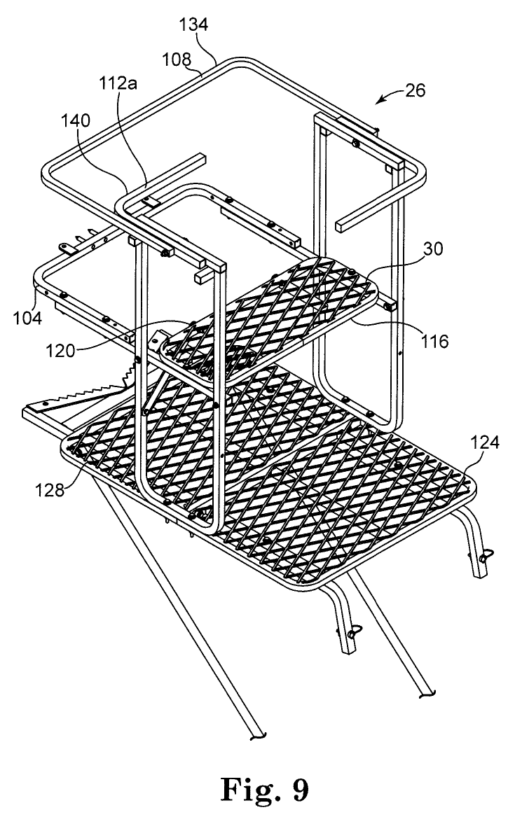

Alternatively, as shown in FIGS. 9-11, the frame 26 can be configured such that one user can face the front portion 124 of the platform 22 and another user can face the rear portion 128 of the platform 22. In the arrangement shown in FIG. 9, the gun railing 108 has been placed in the second position 134 proximate the rear portion 128 of the platform 22. A first backrest 112a has been moved from the first position 140 proximate the rear portion 128 of the platform 22 to the second position 144 proximate the front portion 124 of the platform 22. A second backrest 112b remains in the first position 140.

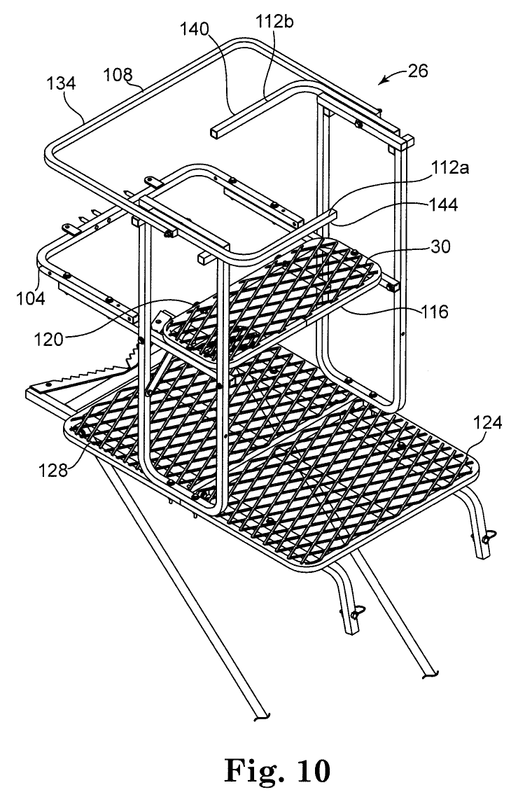

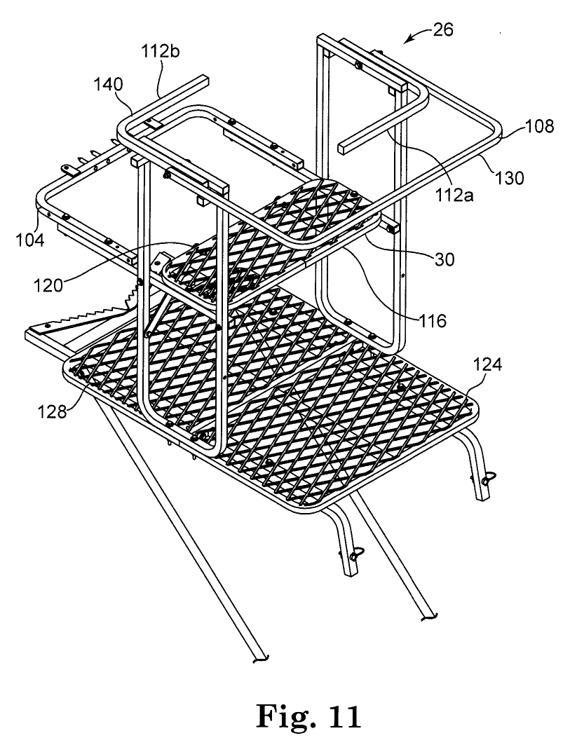

In the arrangement shown in FIG. 10, the first backrest 112a remains in the first position 140 and the gun railing 108 and the second backrest 112b have been placed in their respective second positions 134 and 144. Likewise, as shown in FIG. 11, the first backrest 112a is moved from the first position 140 to the second position 144 while the gun railing 108 and second backrest 112b remain in their respective first positions, 130 and 140.

The ability to arrange the frame 26 to allow different shooting directions may also benefit the left-handed shooter, increasing their options for angling for a spot to shoot from. Additionally, the ability to reconfigure the frame 26 also allows for both the right-handed shooter and the left-handed shooter to comfortably share the tree stand.

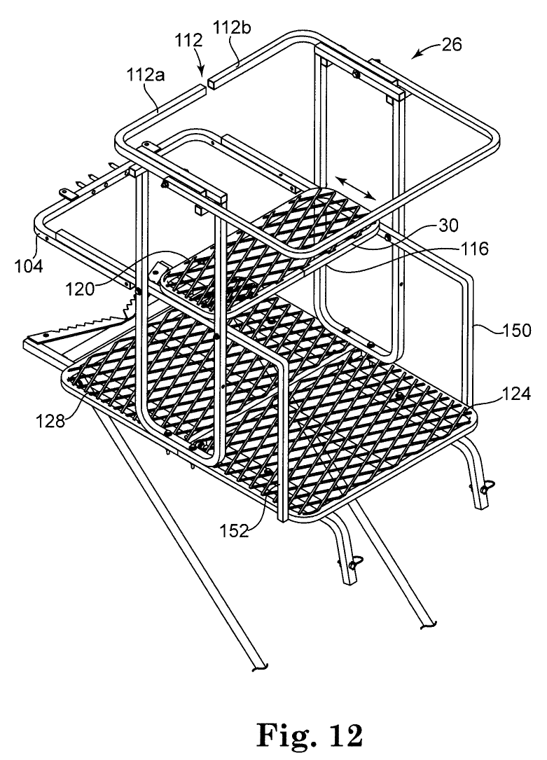

FIG. 12 is a close-up perspective view of the upper portion of the tree stand 10 according to another embodiment of the present invention. As shown in FIG. 12, the frame 26 includes a pair of supports 150, 152 extending generally from the front portion of the platform to the rear portion of the platform. The multi-directional seat 30 is releasably attached to the supports 150, 152. The multi-directional seat 30 preferably includes a slideable bracket or other suitable fastening mechanisms to releasably attach to the supports 150, 152. The multi-directional seat 30 can preferably be positioned between the front and rear portions 124, 128 of the platform 22 by a user without the need for tools.

According to one embodiment of the present invention, the multi-directional seat 30 is releasably attached to the supports 150, 152 and repositionable at a plurality of locations between the front portion 124 and the rear portion 128 of the platform 22. Alternatively, the multi-directional seat 30 is slideably attached to the frame 26 along the supports 150, 152, from the front and rear portions 124, 128 of the platform 22. According to a further embodiment, the multi-directional seat 30 is infinitely positionable along the frame 26 between the front portion 124 and the rear portion 128 of the platform 22. The multi-directional seat 30 is generally constructed out of the same material as the platform, but can include padding to make a long stay in the stand 10 more comfortable and enjoyable.

FIG. 13 illustrates yet another embodiment of the present invention. The portable tree stand 10 of FIG. 1 is configured as a hanging tree stand, without the attached ladder 16. The hanging portable tree stand 10 is secured to a tree 12 or another vertical support using one or more of the flexible members 62. Optional stabilizing structure 20 extends between the front portion 124 of the platform 22 and the tree 12. The stabilizing structure 20 is preferably pivotally attached to the platform 22 and secured to the tree 12 using the bracket 60 and flexible member 62 shown in FIG. 1. The hanging tree stand 10 of FIG. 13 is typically accessed using commercially available climbing sticks or tree climbers.

In reference to FIGS. 1-12, the set up and usage of the tree stand 10 will be described. The entire tree stand 10 is first transported, in a folded or otherwise transportable arrangement to the tree 12 or another vertical support where it is desired to be put in use. The unassembled tree stand 10 is placed on the ground prior to assembly. The ladder 16 and the platform 22 including the frame 26 and multi-directional seat 30 are assembled separately. Next, the platform 22, including the frame 26, is secured to an upper portion 32 of the ladder 16.

The assembled tree stand 10 is then lifted and placed in position against the tree 12 with the tree blade 98 firmly gripping the tree trunk so as to provide additional stability to the tree stand 10. The stabilizing structure 20 is assembled according to one of the configurations as shown in FIGS. 1-3, and secured to the tree 12 by wrapping a nylon strap, chain, or other flexible member 62 around the tree 12 and engaging a length of the strap in the bracket 60 and tightening the flexible member 62 in the bracket 60 so as to firmly engage the tree 12. Additional flexible members 62 may be used as necessary or desired at different locations on the tree stand 10. The ladder 16 is then stable enough to be climbed to complete any necessary adjustments to the frame 26.

The tree stand user climbs the ladder 16 and mounts the platform 22. Once on the platform 22, the user or users can arrange the frame 26 so as to face the direction of their choice. Additionally, the multi-directional seat 30 can be adjusted along various positions between the front portion 124 or the rear portion 128 of the platform 22 as necessary or desired by the user or users. A proper safety harness should always be worn when using the tree stand 10.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

1-44. (canceled)

45. A portable tree stand attachable to a tree or other vertical support, the tree stand comprising:
a platform;
a frame attached to the portable tree stand and located above the platform, the frame comprising at least one railing; and
at least one multi-directional seat attached to the frame, the multi-directional seat comprising a front edge and a rear edge, the multi-directional seat positioned on the frame so that a front portion of the platform extends beyond the front edge of the multi-directional seat and a rear portion of the platform extends beyond a rear edge of the multi-directional seat, such that a user can sit facing at least the front portion or the rear portion of the platform.

46. The portable tree stand of claim 45 wherein the portable tree stand is a hanging tree stand.

47. The portable tree stand of claim 45 comprising:
at least one stringer;
a plurality of rungs attached to the at least one stringer in a spaced apart configuration; and
at least one stabilizing structure adapted to attach the ladder to the tree or other vertical support.

48. The portable tree stand of claim 45 wherein the railing is adapted to pivot between at least a first position and a second position.

49. The portable tree stand of claim 45 wherein the railing comprises a moveable shooting rail proximate the front portion of the platform in the first position and proximate the rear portion of the platform in the second position.

50. The portable tree stand of claim 45 wherein the railing comprises at least one backrest pivotally attached to the frame portion and at least one shooting rail pivotally attached to the frame.

51. The portable tree stand of claim 45 comprising a split backrest including a first backrest and a second backrest, the first and second backrests each independently pivotable between at least a first position and a second position.

52. The portable tree stand of claim 45 wherein the frame assembly is adapted to be configured for a first user to sit facing the front portion of the platform, and a second user to simultaneously sit facing the rear portion of the platform.

53. The portable tree stand of claim 45 comprising:
a ladder attached to the portable tree stand; and
at least one stabilizing structure comprising at least one elongated rigid member attached at a first end to the ladder and at a second end to the tree, the first and second ends of the stabilizing structure located below the platform.

54. The portable tree stand of claim 45 comprising:
a ladder attached to the portable tree stand; and
at least one stabilizing structure comprising at least one flexible tension member attached at a first end to the ladder and at a second end to the tree at a location below the platform.

55. The portable tree stand of claim 45 wherein the multi-directional seat is releasably attached to the frame and repositionable at a plurality of locations between the front portion and the rear portion of the platform.

56. The portable tree stand of claim 45 wherein the multi-directional seat is slideably attached to the frame between the front portion of the platform and the rear portion.

57. The portable tree stand of claim 45 comprising:
a ladder located substantially below the platform;
a first stabilizing member having a first end attached to the ladder and a second end attached to the tree at a location below the platform; and
a second stabilizing member having a first end attached to the ladder and a second end attached to the first stabilizing member.

58. The portable tree stand of claim 45 comprising:
a ladder located substantially below the platform;
a first stabilizing member having a first end attached to the ladder and a second end attached to the tree at a location below the platform; and
a second stabilizing member having a first end attached to the ladder and a second end attached to the tree at a location below the platform, wherein the first and second stabilizing members are pivotally attached to one another at a mid point.

59. A portable tree stand attachable to a tree or other vertical support, the tree stand comprising:
a ladder comprising at least one stringer and a plurality of rungs attached thereto in a spaced apart configuration;
a platform secured to an upper portion of the ladder;
a frame assembly attached to the portable tree stand and located above the platform, the frame assembly comprising at least one multi-directional seat and at least one pivoting member, wherein the multi-directional seat and pivoting member are adapted to be configured for a user to sit facing a front portion of the platform or a rear portion of the platform; and
at least one stabilizing structure adapted to attach the ladder to the tree or other vertical support.

60. The portable tree stand of claim 59 wherein the frame assembly is adapted to be configured for a first user to sit facing the front portion of the platform, and a second user to sit facing the rear portion of the platform.

61. The portable tree stand of claim 59 wherein the railing comprises a moveable shooting rail proximate the front portion of the platform in the first position and proximate the rear portion of the platform in the second position.

62. The portable tree stand of claim 59 comprising a split backrest including a first backrest and a second backrest, the first and second backrests each independently pivotable between at least a first position and a second position.

63. The portable tree stand of claim 59 wherein the frame assembly is adapted to be configured for a first user to sit facing the front portion of the platform, and a second user to simultaneously sit facing the rear portion of the platform.

64. A portable tree stand attachable to a tree or other vertical support, the tree stand comprising:
a frame assembly attached to the portable tree stand and located above the platform, the frame assembly comprising at least one multi-directional seat and at least one pivoting member, wherein the multi-directional seat and pivoting member are adapted to be configured for a user to sit facing a front portion of the platform or a rear portion of the platform.

65. The portable tree stand according to claim 64 wherein the tree stand is a hanging tree stand.

66. The portable tree stand according to claim 64 wherein the tree stand is a ladder stand.

67. A method of using a tree stand to hunt or observe game, the method comprising the steps of:
attaching a frame assembly to a platform, the frame assembly comprising at least one railing;
attaching at least one multi-directional seat to the frame assembly at a location that permits a user to sit facing a front portion of the platform or a rear portion of the platform; and
securing the tree stand to a tree or another vertical support.

68. The method according to claim 67 further comprising arranging the frame assembly to allow a first user to face in the first direction and a second user to face in a second direction.

69. The method according to claim 67 further comprising adjusting the multi-directional seat at a position located between the front portion and the rear portion of the platform.
